(19) United States
(12) Patent Application Publication
(10) Pub. No.: US 2014/0131153 A1
(43) Pub. Date: May 15, 2014

(54) Hydrodynamic Retarder and Method for Controlling the Power Transmission of Such a Retarder

(71) Applicant: VOITH PATENT GMBH, Heidenheim (DE)

(72) Inventors: Dieter Laukemann, Crailsheim (DE); Werner Adams, Crailsheim (DE); Jurgen Kibler, Aalen (DE)

(21) Appl. No.: 14/113,564

(22) PCT Filed: Mar. 7, 2013
(86) PCT No.: PCT/EP2013/054635

§ 371 Date: Jan. 22, 2014

(30) Foreign Application Priority Data
Mar. 7, 2012 (DE) 102012004332.5

(51) Int. Cl. B60T 1/087; B60T 10/02

(52) U.S. Cl. CPC B60T 1/087; B60T 10/02
USPC 188/274; 188/296

(57) ABSTRACT

The invention concerns a method for controlling the power transmission of a hydrodynamic retarder, comprising a rotating bladed rotor and a bladed stator or a bladed counter-rotor rotating against the direction of rotation of the rotor, which form together a working chamber which selectively can be filled with a working medium via an inlet and can be drained via an outlet; whereas the working chamber is filled with a working medium in braking mode, and a braking torque is generated with the hydrodynamic retarder and in a non-braking mode the working chamber is emptied of working medium down to a certain residual amount and substantially no braking torque is generated with the hydrodynamic retarder. The invention is characterised by the following step: In non-braking mode, working medium is injected into the working chamber of the hydrodynamic retarder for adjusting the residual amount, said working medium being extracted from a stock of working medium, which is provided outside the working chamber in a working medium storage tank using an idle pump.

The present invention concerns a method for controlling the power transmission of a hydrodynamic retarder, as well as a hydrodynamic retarder, for instance for buses, lorries or rail vehicles.

Hydrodynamic retarders contain a working chamber, which can be filled with a working medium, to transmit torque hydrodynamically from a driven primary blade wheel (rotor) to a stationary secondary blade wheel, hence also called stator. Instead of a stationary secondary blade wheel, a secondary blade wheel rotating against the direction of rotation of the primary blade wheel can also be provided, to form a counter-rotating retarder. By driving the rotor by means of a rotor shaft to be braked, for instance of a transmission output shaft or of a shaft fixedly (cardan shaft) and indirectly connected to the drive wheels of the motor vehicle, the working medium in the rotor is accelerated radially and outwardly and enters the stator, in which it is delayed to flow radially and inwardly. The circular flow thus formed enables to transmit the torque, here designed as a braking torque of the retarder, from the rotor to the stator. The primary blade wheel is thus delayed and in particular, the rotor shaft connected to the primary blade wheel in a torque-proof manner, is also delayed.

The size of the transmitted braking torque in braking mode hence depends on the so-called filling level of the hydrodynamic retarder. In non-braking mode, the working chamber of the retarder conversely is emptied of the working medium.

The adjustment of a certain filling level of the working chamber of a hydrodynamic retarder and hence the control of the transmitted braking torque can take place either by applying a control pressure to the working medium conveyed or to be conveyed to the working chamber or by controlling the flow cross-section in inlet or outlet of the hydrodynamic retarder by means of a regulating valve, in particular a proportional valve, without applying a control pressure to the working medium conveyed to the working chamber.

To apply a control pressure to the working medium of the hydrodynamic retarder, it is for instance known to provide a storage chamber for the working medium, in particular oil, with a membrane subjected to compressed air. The membrane separates the working medium from an air chamber which is subjected to a compressed air system, in particular a vehicle compressed air system. The membrane or a piston having the same effect or similar is however not strictly necessary. The control medium pressure, in particular air pressure, can be exerted directly on the stock of working medium. The air pressure can be varied as a control pressure by means of a pneumatic valve and hence more or less working medium can be pressed or repelled from the storage chamber into the hydrodynamic circuit of the working medium in the working chamber.

The present invention concerns both variations above mentioned for adjusting a certain filling level of the working chamber in braking mode.

Generally, in non-braking mode of hydrodynamic retarders further to the rotation of the rotor losses appear (so-called ventilation or no-load losses) because a torque is transmitted between the blade wheels in spite of an emptied working chamber. The retarder hence generates an undesirable braking torque.

To prevent said no-load losses, it is known to move both blade wheels of the retarder in non-braking mode away from each other axially, to block such torque transmission. Other measures provide the installation of disturbing elements such as panels or a locking medium beam into the working chamber or the sucking dry of the working chamber, so as to generate a vacuum. Moreover, attachments have been known which specifically leave a certain residual amount of working medium for obtaining an optimal performance loss value, i.e. a minimal ventilation loss, in the working chamber. Consequently DE 101 50 681 A1 suggests conveying in non-braking mode working medium to the working chamber from a tank arranged higher than the working chamber and provided additionally to the working medium reservoir.

The residual amount of working medium situated in non-braking mode in the working chamber heats up and should hence be cooled down in an external circuit. Said external circuit is guided as a rule through its own heat exchanger which is provided in addition to the relatively larger heat exchanger in the external circuit for the braking operation. If the comparatively small volume flow of working medium of the non-braking mode were namely conveyed through the large heat exchanger of the braking operation the air of the working medium carried away from the working chamber could build up in the heat exchanger, which on the one hand is detrimental for the heat exchanger and on the other hand, when switching on the retarder, i.e. during the changeover from non-braking mode to braking mode, could blow dry the working chamber, just after the beginning of the filling process.

It goes without saying that providing its own “small” working medium circuit with its own heat exchanger is wasteful and costly.

It has appeared in practice that the performance loss of the known hydrodynamic retarder, in whose working chamber in non-braking mode working medium flows in from the tank arranged higher, rises significantly with increasing rotational speed.

Publication DE 20 2005 003 329 U1 describes a retarder-rotary pump-assembly, by which the impeller wheel of the water pump of the vehicle cooling circuit is positioned axially besides the rotor of the hydrodynamic retarder on a common shaft with the said, to detect the outflowing working medium via gaskets by means of which the rotor is sealed with respect to a casing of the retarder and to return it to the vehicle cooling circuit. If coolant should be circulated in the cooling circuit only with the coolant pump and hence the retarder is in idle mode, the gaskets can be cooled with water from the water pump, water which then flows into the working chamber of the retarder on the one hand and into the atmosphere in vaporous state on the other hand.

The object of the invention is then to provide a hydrodynamic retarder and a method for controlling the power transmission of a hydrodynamic retarder which are improved with respect to the state of the art. In particular, the losses should be minimised in non-braking mode of the hydrodynamic retarder even at high rotational speeds. Besides, the construction, production and adjustment costs of such a hydrodynamic retarder should be reduced.

The object of the invention is solved with a method for controlling the power transmission of a hydrodynamic retarder as well as with such a hydrodynamic retarder according to the independent claims. Advantageous and particularly appropriate embodiments of the invention are disclosed in the dependent claims.

A method according to the invention for controlling the power transmission of a hydrodynamic retarder, comprising a rotating bladed rotor and a bladed stator or a bladed counter-rotor rotating against the direction of rotation of the rotor, which form together a working chamber which can be filled with a working medium via an inlet and can be drained via an outlet, whereas the working chamber is filled with a working medium in braking mode and a braking torque is generated with the hydrodynamic retarder and in a non-braking mode the working chamber is emptied of working medium down to a certain residual amount and substantially no braking torque is generated with the hydrodynamic retarder, includes the following step: Working medium is injected in non-braking mode with an idle pump into the working chamber of the hydrodynamic retarder for adjusting the predetermined residual amount.

Contrary to a suction of the working medium from the working chamber with a pump or for generating a vacuum in the working chamber with a pump, working medium is hence pumped into the working chamber using an idle pump, i.e. the idle pump is positioned in the flow direction of the working medium before an inlet, in particular just before an outlet into the working chamber. Indeed the inventors have recognised that the excessive increase in no-load losses with rising rotational speed of the retarder or of its rotor is justified inasmuch as the retarder increasingly expels working medium of the residual amount of working fluid from the working chamber thanks to its pumping effect, whereas conversely working medium only flows into the working chamber due to the force of gravity since the retarded does not present the expected suction effect. The amount of working medium flowing into the working chamber in non-braking mode (volume flow of working medium or mass flow of working medium) is hence constant which reduces the residual amount of working medium remaining in the working chamber when the amount of discharged working medium (mass flow or volume flow) rises with increasing rotational speed. The optimal residual amount of working medium for adjusting a minimal ventilation loss conversely does not depend on the rotational speed of the retarder and is in particular constant. Since then the working medium according to the invention in non-braking mode is pumped into the working chamber of the hydrodynamic retarder, the optimal residual amount of working medium, in particular a constant residual amount of working medium, can be guaranteed.

Advantageously, an idle pump is used, whose outer diameter of at least one impeller wheel of the same is smaller than the outer diameter of the working chamber, in particular is smaller than the diameter, on which the orifice of the inlet is positioned in the working chamber, or is smaller than the inner diameter of the working chamber.

According to a preferred embodiment of the method the volume flow of working medium or mass flow of working medium supplied in the working chamber in non-braking mode is proportional to the rotational speed of the rotor and/or counter-rotor (the latter in a version with a counter-rotating retarder) so that with a comparatively low rotational speed the volume flow of working medium or mass flow of working medium injected in the working chamber with the idle pump drops and correspondingly increases with a comparatively greater rotational speed.

Advantageously, the idle pump is driven directly or indirectly through the rotor or the counter-rotor of the retarder. For example, the impeller wheel of an idle pump is carried by the rotor or of the rotor shaft respectively by the counter-rotor or the counter-rotor shaft to that effect.

Another embodiment provides that in braking mode the amount of working medium contained in the working chamber by is varied by subjecting the stock of working medium more or less strongly with a control pressure, said stock of working medium being situated outside the working chamber in a working medium storage tank, whereas according to the control pressure more or less working medium is forced into the working chamber from the stock of working medium, and that in non-braking mode the working medium storage tank is vented completely by means of a ventilation unit. To do so, the flow rate of the idle pump, which in particular conveys the working medium from the stock of working medium, can be adjusted very precisely.

A particularly cost efficient obtainable embodiment suggests that the idle pump comprises an impeller wheel in the form of a disk with a radially internal inlet region for working medium and a radially external outlet region for working medium, whereas the working medium is conveyed from the inlet region to the outlet region and from the latter into the working chamber by driving the impeller wheel and by the effect of the centrifugal force. The working medium can be guided by way of example from the stock of working medium to the inlet region, in particular via a connection for conveying the working medium, provided in addition to the external working medium circuit in which the working medium is circulated in braking mode.

A hydrodynamic retarder realised according to the invention comprises a rotating bladed rotor and a bladed stator or a bladed counter-rotor rotating against the direction of rotation of the rotor, which in braking mode form together a working chamber which selectively can be filled with a working medium via an inlet and can be drained via an outlet, whereas the working chamber can be filled with a working medium in braking mode in order to adjust a braking torque with the hydrodynamic retarder and in a non-braking mode the working chamber is emptied of working medium down to a certain residual amount and substantially does not generate any braking torque. To do so, there is an idle pump which injects working medium into the working chamber in non-braking mode.

The conveyed volume flow or the mass flow of working medium supplied to the working chamber by means of the idle pump can be selected in such a way that said volume flow of working medium or mass flow of working medium discharged equals that from the working medium (further to the pumping effect of the retarder). In other words, it means that the whole residual amount of working medium present in the working chamber in non-braking mode remains (practically) constant through steady supply by means of the idle pump and steady discharge of the pumping effect of the retarder. Said amount of working medium supplied steadily to the working medium in non-braking mode respectively the residual amount remaining in the working chamber hence corresponds to a fraction of the volume of working chamber. Said amount is thus significantly smaller than the amount which is necessary to adjust the minimal possible braking torque which can be adjusted in braking mode with the retarder. To do so, the residual amount remaining in the working chamber is selected in such a way that non-braking mode the retarder is not energised (and hence a brake) and simultaneously the no-load losses can be kept as small as possible.

Furthermore, the whole residual amount of working medium situated in the working chamber circulates for heat discharge. An external cooling circuit is preferably provided into which the working medium discharged via the outlet is cooled in a heat exchanger so that the working chamber in such a case, as an integral part of the external cooling circuit, is flooded constantly. A steady circulation to and from the working chamber is achieved through said steady exchange of the particularly whole residual amount of working medium from the working chamber. To do so, the heat generated from the residual amount of working medium by fluid friction in non-braking mode is discharged from the working chamber. Damages of the retarder can thus be avoided efficiently. Said cooling circuit in non-braking mode can use the same heat exchanger as the external working medium circuit in braking mode. It is hence not necessary to design said cooling circuit of the non-braking mode separately from the external working medium circuit in braking mode. For instance, the pipes of the “small” cooling circuit for the non-braking mode emerge in the working medium storage tank and/or in pipes of the external cooling circuit for the braking mode. Ideally, the hydrodynamic retarder or the working chamber of the hydrodynamic retarder should have their own connections, separately from the connections of the external cooling circuit for the braking mode, namely for the cooling circuit in non-braking mode.

Measures can be taken to prevent any undesirable or excessive mixture of the working medium with air in the working chamber of the hydrodynamic retarder in non-braking mode. For example, the outlet for the working medium which circulates in non-braking mode runs to do so in radial direction of the working chamber. Moreover, a so-called pilot tube can be provided which in particular protrudes into a casing of the hydrodynamic retarder in the direction of the working chamber or protrudes into the working chamber and extends in radial direction.

In addition to the outlet via which the external cooling circuit is connected to the working chamber, a deviation for working medium is preferably provided in non-braking mode, which deviation presents the pilot tube extending to the working chamber in radial direction and/or protruding into said working chamber. The pilot tube hence serves as an accumulation point for tapping surplus working medium from the working chamber.

The pilot tube can then protrude into a gap which delineates the rotor, the counter-rotor, stator and/or at least a casing enclosing one of these components. Preferably, the pilot tube reaches in the region of the gap between a rotating impeller wheel and the casing.

Advantageously, the pilot tube is connected directly to the inlet region or indirectly connected to the inlet region via at least one connection pipe emerging into the inlet region, in a flow-guiding manner. Consequently, the idle pump can act upon the pilot tube as a back-up to discharge working medium from the working chamber via the pilot tube.

In said at least one connection pipe, which connects the pilot tube indirectly to the inlet region, a heat exchanger can be arranged for cooling the working medium tapped via the pilot tube. Preferably, the heat exchanger comprises however a first cooling system for cooling the working medium tapped through the pilot tube and a second cooling system for cooling the working medium discharged via the outlet. To do so, both cooling systems can be separated from one another fluidly as regards the working medium. The separate cooling circuit avoids an inclusion of air, when taping the working medium via the pilot tube into the second cooling system, in which the working medium discharged through the outlet flows. This prevents the heat exchanger from being filled with air, whereas its cooling capacity would drop.

Preferably pure working medium and not by way of example a mixture of air and working medium is conveyed to the working medium from the idle pump. The pump hence serves purely to convey working medium from the working medium storage tank to the working chamber. In particular, the working medium is accelerated by means of the idle pump out of the working medium storage tank only inasmuch as it is necessary for conveying the working medium to the working chamber. It means in other words that the static partial pressure of the working medium in the connection pipe between the working medium storage tank and the working chamber for adjusting a cooling flow by means of the idle pump prevails with respect to the kinetic partial pressure; there is no significant pressure rise of the working medium along this connection pipe, so that the inlet velocity with which the working medium flowing out of the working medium storage tank reaches the idle pump corresponds essentially to the outlet velocity, except for friction losses, in the flow direction downstream of the idle pump in the working chamber. The working medium reaches into the working chamber practically pressureless. It also means that in the connection pipe between working medium storage tank and working chamber, in which the idle pump is arranged, there are no nozzles whatsoever for accelerating the working medium and for excessive accumulation of pressure. Other embodiments are however possible.

The connection pipe, via which the idle pump conveys working medium from the working medium storage tank into the working chamber should advantageously emerge below the working medium surface, in particular the oil surface, in the working medium storage tank.

The idle pump can hence be designed in such a way that said pump exclusively in non-braking mode enables or supplies the inflow of working medium to the working chamber according to the invention. In other words, said pump serves exclusively for maintaining a flow of working medium through the working chamber with the retarder in non-braking mode. The task of the adjustment of a filling level for exerting a hydrodynamic braking torque in braking mode is achieved with a separate pressurisation system.

The idle pump can preferably be the sole pump provided in the external cooling circuit.

The invention will now be described more in detail in the light of the appended figure by way of example.

The figures are as follows:

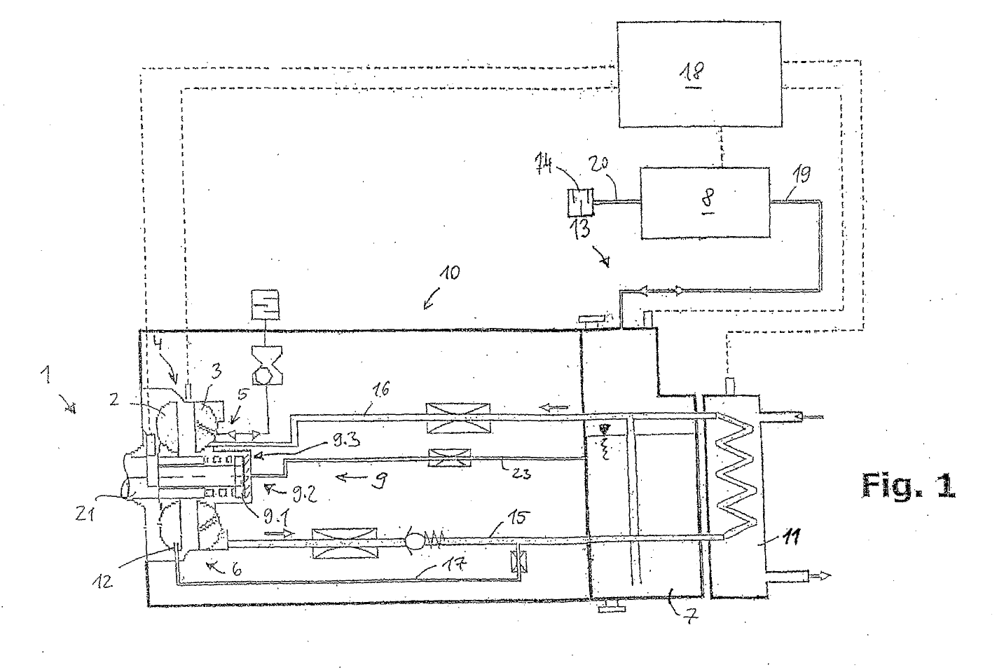

FIG. 1 shows a diagrammatical illustration of a hydrodynamic retarder arranged in a braking system of a vehicle according to a first embodiment;

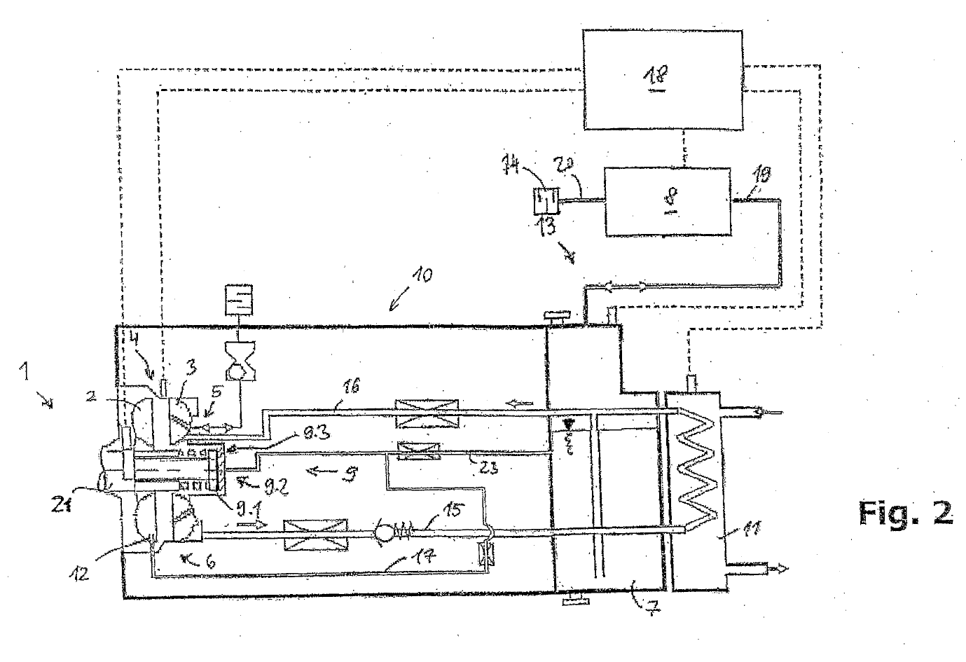

FIG. 2 shows a diagrammatical illustration of a hydrodynamic retarder arranged in a braking system of a vehicle according to a further embodiment;

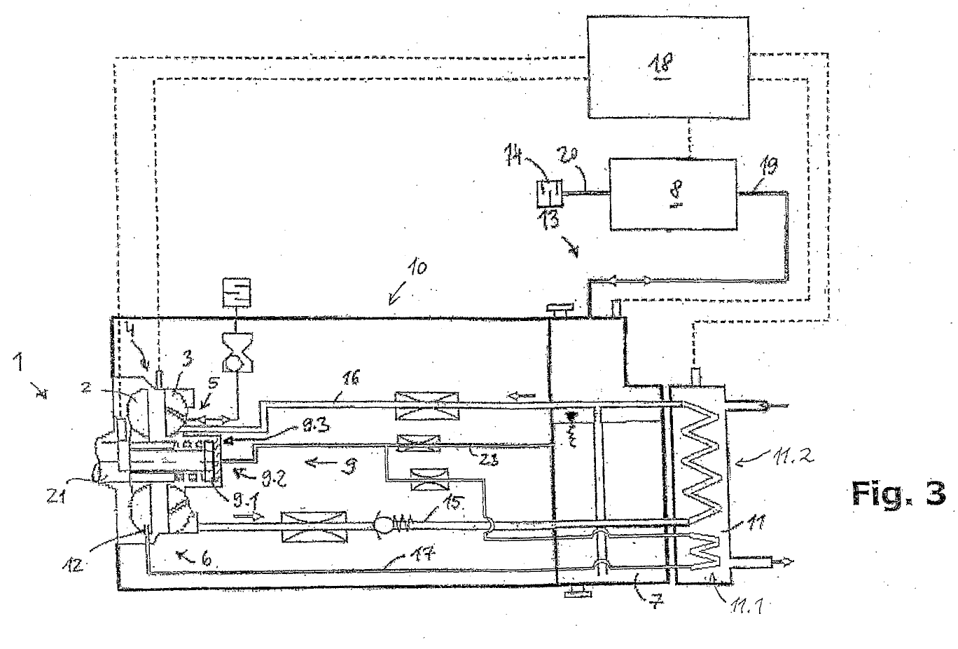

FIG. 3 shows a diagrammatical illustration of a hydrodynamic retarder arranged in a braking system of a vehicle according to a third embodiment.

FIG. 1 shows a hydrodynamic retarder 1 as a part of a braking system of motor vehicle with a external cooling circuit for guiding the working medium, a cooling circuit which serves for evacuating the heat generated in the working medium in braking mode of the hydrodynamic retarder 1. In the present case, the working medium is oil. The hydrodynamic retarder 1 could be also part of a cooling circuit of the motor vehicle whereas the working medium could then be water or a water mixture.

The following components are arranged in the external cooling circuit, as represented in FIG. 1, in the flow direction of the working medium: the hydrodynamic retarder 1, including a rotor 2 and a stator 3, which form together a toroidal work space 4, the orifice of a first connection pipe 15 from the hydrodynamic retarder 1 to a heat exchanger 11, with which working medium oil, also designated as an oil cooler, a throttle of constant cross-section arranged fixedly behind said orifice, as well a return valve connected downstream of the throttle, the heat exchanger 11, an orifice of a second connection pipe 16 from the heat exchanger 11 to the working chamber 4 of the hydrodynamic retarder 11 as well as an additional throttle. In this instance, the second connection pipe 16 emerges into an inlet 5, via which the working chamber 4 can be filled with working medium from the second connection pipe 16 of the external cooling circuit. The working medium is returned from the working chamber 4 into the external working medium circuit via an outlet 6, into which the first connection pipe 15 emerges.

Here, the heat exchanger 11 is arranged on a working medium storage tank 7 for absorbing the working medium which is not necessary in the working chamber 4 at the moment. The working medium storage tank 7 and the heat exchanger 11 could be regrouped to form a single construction unit, which should not compulsorily be the case. Also the hydrodynamic retarder 1, the illustrated cooling circuit, the working medium tank 7 and/or the heat exchanger 11 could be regrouped to form such a single construction unit. The heat exchanger 11 is connected in this instance to a cooling circuit of the vehicle (not shown) for cooling the working medium of the hydrodynamic retarder 1 in order to deliver the heat of the working medium generated in the external cooling circuit to the said.

For adjusting a certain filling level of the working chamber 4 in braking mode of the hydrodynamic retarder 1, the working medium storage tank 7 is connected to a pressurisation system 8 for operating the working medium contained therein via a flow directing connection, here designated with a working pipe 19. A control device 18 associated in particular with the hydrodynamic retarder 1 enables to calculate a corresponding superimposed pressure, designated below as a control pressure, according to a breaking power to be corrected with the hydrodynamic retarder 1, respectively to a braking torque to be corrected; for instance to a braking step selected by means of a selector lever (not shown).

The control pressure is adjusted by means of the pressurisation system 8 in such a way that the control device 18 more or less opens a valve in a compressed air line (non illustrated) of the pressurisation system 8, in which compressed air comes from the vehicle compressed air system (also non illustrated). The valve adjusts the pressure (air pressure) in the working line 19 for operating the working medium storage tank 7 according to its opening cross-section. The latter is filled partially with air, partially with working medium. The working line 19 is connected to do so in the region of a pressure medium connection 13 of the working medium tank 7 with its air side above a fluid surface of the working medium to operate it by guiding compressed air.

The working line 19 applies on the one hand the control pressure adjusted using the pressurisation system 8 to the working medium contained in the working medium storage tank 7, to repel said working medium depending on the control pressure more or less from the working medium storage tank 7 into the external cooling circuit and hence into the working chamber 4 of the retarder 11. The pressure on the liquid level increases the working medium into a channel which emerges below the fluid surface and is connected to the second connection pipe 16 (seen in the flow direction behind the heat exchanger 11) for conveying the working medium, in order to guide working medium from the working medium storage tank 7 via the inlet 5 to the working chamber 4. The inlet 5 can be designed in the form of slits integrated in the stator 3 and/or rotor 2. Such slits can be provided also in addition to the inlet 5 for supplying working medium into the working chamber 4 and by way of example be connected to the second connection pipe 16 in a flow-guiding manner. The same also applies with an embodiment as a counter-rotating retarder for the counter-rotor (not-illustrated).

If conversely the control pressure in the working medium storage tank 7, which pressurises the working medium therein, is reduced, inasmuch as the pressure decreases in the working line 19 by reducing the opening cross-section or closing said valve, and preferably the compressed air can additionally escape into the atmosphere from the working medium storage tank 7 via a ventilation unit 20, the working fluid can flow from the external cooling circuit through the channel extending down to below the fluid surface back into the working medium storage tank 7. The working medium flowing into the working medium storage tank 7 is hence separated from the portion of the working medium circulating in the external cooling circuit.

As further illustrated in FIG. 1, a first end of a third connection pipe 17 emerges in the region of the outlet 6 of the retarder 1 or of the working chamber 4, whereas conversely its second end in the second connection pipe 16, here seen in the flow direction of the working medium, emerges behind the return valve or before the heat exchanger 11. A pilot tube 12 can be connected to the end of the third connection pipe 17 emerging in the working chamber 4, a pilot tube which protrudes into the working chamber 4 from radially and outwardly into the region of the rotor 2 or of the stator, to discharge working medium from the said in the form of a dynamic pressure pump.

As can be seen further from FIG. 1, in the present case the first end of the third connection pipe 17 emerges at any other location in the outlet 6 as that of the first connection pipe 15. It goes without saying that each of both connection pipes 15, 17 may also have its own outlet in the retarder 1. If one considers the first connection pipe 22 as a main branch of the external cooling circuit, so the third connection pipe 17 represents in this case an adjacent branch or respectively a parallel branch of the same. This could be quite different.

The stator 3 is here part of a casing enclosing the retarder 1 and comes to a standstill, whereas conversely the rotor 2 is brought into rotation indirectly via a rotor shaft 21. The rotor shaft 21 is enclosed by a hollow shaft 22 in the present instance. The rotor 2 sits in a torque-proof manner on the hollow shaft 22 and rotates together with the said. The hollow shaft 22 carries on at least one section of its inner diameter a thread, such as a steep thread and is mounted to slide axially on the rotor shaft 21. The latter shows a complementary external thread so that when filling the working chamber 4 with working medium during the changeover to the braking mode further to a rotational movement of the rotor shaft 21 the hollow shaft 22 with the rotor 2 is then moved relatively on the rotor shaft 21 along its longitudinal axis opposite to a elastic force of a spring acting as a recall force, then to be carried away by the rotor shaft 21. The spring serves to disconnect the rotor 2 again automatically from the stator 3, in particular when emptying the working chamber 4.

By disengaging the rotor 2 from the stator 3, the performance loss of the hydrodynamic retarder 1 can be minimised during the non-braking mode. This position is shown in FIG. 1.

The disengagement takes places exclusively in non-braking mode, whereas conversely the rotor 2 is again brought into engagement in braking mode hermetically with the stator. The axial displacement of the rotor 2 illustrated here with respect to the stator 3 is however not strictly necessary for the invention.

An idle pump 8 is provided for minimising the no-load losses by means of which working medium can be conveyed into the working chamber 4 in non-braking mode. The idle pump 9 hence comprises an impeller wheel 9.1, which is designed as a disk in the easiest case and shows an inlet region 9.2 for supplying working medium as well as an outlet region 9.3 for discharging working medium. For example, the inlet region 9.2 (suction side) can be connected to the working medium storage tank 7 in a flow-guiding manner via an additional connection pipe 23 connected in parallel to the second connection pipe 16, whereas said pipe emerges below the fluid surface of the working medium in the working medium storage tank 7 to avoid an air suction. Alternatively, the connection pipe 23 could emerge in the connection pipe 16, before or behind the throttle arranged there.

The impeller wheel 9.1 is designed as a disk, the working medium can thus be supplied to the inlet region 9.2 centrally to the impeller wheel 9.1 and here coaxially to the rotor shaft 21.

The outlet region 9.3, also designated as the pressure-side of the idle pump 9, is here arranged in the region of inlet 5, radially and outwardly on the impeller wheel 9.1. The outlet region 9.3 here emerges here directly, i.e. without intermediate connection of additional values influencing the flow of working medium such as nozzles, valves or throttles in the region of the inlet 5.

With the retarder 1 in non-braking mode, working medium is conveyed via the connection pipe 23 from the working medium storage tank 7 into the working chamber 4 constantly due to the impeller wheel 9.1 rotating together with the rotor shaft 21 whereas in such a case, the volume flow of working medium conveyed to the working chamber 4 from the idle pump 9 constantly depending on the current rotor rotational speed. It is thus guaranteed that during the whole non-braking mode the adjusted residual amount, remaining in the working chamber is always constant independent of the pumping effect and hence the rotational speed of the (counter-) rotor.

It is not harmful if the idle pump 9 is constantly open due to the fixed flow cross-section of the adjusted throttle and hence conveys working medium into the working chamber 4 also in braking mode since the volume flow of working medium conveyed from the said due to the sizing of the idle pump 9 only corresponds to a fraction of the volume flow supplied to the working chamber 4 in braking mode. Consequently, the idle pump 9 is not suitable to the exclusive filling of the working chamber 4 with working medium for adjusting a braking torque with the retarder 1 in braking mode. If desirable, measures can also be taken independent of the embodiment illustrated in the figure to prevent working medium from being fed with the idle pump 9 into the working chamber 4 in braking mode. Such a measure would be for instance an operable valve (not shown), which could be arranged in the connection pipe 23. In braking mode, it would lock completely the flow cross-section for working medium through the connection pipe 23, whereas conversely said working medium would be released completely in non-braking mode. Also intermediate positions of the valves, in which said valve releases or locks the flow cross-section completely, could be envisaged. Alternately or additionally, the throttle arranged in the connection pipe 23 could also be designed not as a fixed, but an adjustable throttle, which would work analogically to the described valve. The throttle or the valve could then be operated via a corresponding control line (not-illustrated) by the control pressure of the pressure medium of the pressurisation system 8 automatically when activating the braking mode, so that they would close automatically and during the changeover to the non-braking mode, at which the control pressure is withdrawn, they open again automatically.

In order to adjust exactly the amount of working medium conveyed by means of the idle pump 9 in non-braking mode, a ventilation unit 14 can be arranged additionally. in the ventilation unit 20, which valve adjusts a pressure atmospheric in the working medium storage tank 7.

FIG. 2 shows an additional embodiment of the hydrodynamic retarder. To do so, matching components are designated with matching reference signs.

Contrary to the FIG. 1, the connection pipe 17 does not emerge upstream of the return valve in the pipe 15, but downstream of the throttle in the connection pipe 23. Since the pilot tube 12 is connected via the connection pipes 17 and 23 indirectly to the inlet region 9.2 of the idle pump 9, the conveying effect of the working medium tapped from the working chamber 3 via the pilot tube 12 is amplified. As represented, a throttle can be arranged in the connection pipe 17 before emerging into the connection pipe 23.

FIG. 3 shows a third embodiment of the hydrodynamic retarder. Here again, matching components are designated with matching reference signs. The embodiment according to FIG. 3 essentially corresponds to that of FIG. 2, whereas the connection pipe 17 is connected to the heat exchanger 11 upstream of the orifice arranged therein. In the present case, the heat exchanger comprises two cooling systems 11.1, 11.2. The cooling system 11.1 serves for cooling the working medium tapped via the pilot tube 12. The cooling system 11.2 serves conversely for cooling the working medium discharged from the working chamber 3 via the outlet 6. To do so, both cooling systems 11.1, 11.2 can be separated from one another fluidly. This is however not strictly necessary.

### List of Reference Numerals

1 Hydrodynamic retarder
2 Rotor
3 Stator
4 Working chamber
5 Inlet
6 Outlet
7 Working medium storage tank
8 Pressurisation system
9 Idle pump
9.1 Impeller wheel
9.2 Inlet region
9.3 Outlet region
10 Cooling circuit
11 Heat exchanger
11.1 Cooling system
11.2 Cooling system
12 Pilot tube
13 Pressure medium outlet
14 Ventilation unit
15 Connection pipe
16 Connection pipe
17 Connection pipe
18 Control device
19 Working line
20 Vent line
21 Rotor shaft
22 Hollow shaft
23 Connection pipe

1-19. (canceled)

20. A method for controlling the power transmission of a hydrodynamic retarder comprising rotating bladed rotor and a bladed stator or a bladed counter-rotor rotating against the direction of rotation of the rotor, which form together a working chamber which selectively can be filled with a working medium via an inlet and can be drained via an outlet, wherein the working chamber is filled with a working medium, in braking mode, and a braking torque is generated with the hydrodynamic retarder and in non-braking mode, the working chamber is emptied of working medium down to a certain residual amount and substantially no braking torque is generated with the hydrodynamic retarder, the method comprising:
injecting, in non-braking mode, working medium into the working chamber of the hydrodynamic retarder for adjusting the residual amount, said working medium being extracted from a stock of working medium, which is provided outside the working chamber in a working medium storage tank, using an idle pump.

21. The method according to claim 20, wherein in braking mode the amount of working medium contained in the working chamber is varied by more or less strongly subjecting the stock of working medium in the working medium storage tank to a control pressure, whereas according to the control pressure more or less working medium is forced into the working chamber from the stock of working medium, whereas oil in particular is used as a working medium.

22. The method according to claim 20, wherein an idle pump is used, whose outer diameter of at least one impeller wheel of the same is smaller than the outer diameter of the working chamber or is smaller than the diameter, on which the orifice of the inlet is positioned in the working chamber, or is smaller than the inner diameter of the working chamber.

23. The method according to claim 21, wherein an idle pump is used, whose outer diameter of at least one impeller wheel of the same is smaller than the outer diameter of the working chamber or is smaller than the diameter, on which the orifice of inlet is positioned in the working chamber, or is smaller than the inner diameter of the working chamber.

24. The method according to claim 20, wherein the working medium in non-braking mode is forced into the working chamber of the hydrodynamic retarder for adjusting the residual amount, using the idle pump directly from the working medium storage tank and outside sealing elements, by means of which the rotor is sealed hermetically with respect to a casing of the hydrodynamic retarder.

25. The method according to claim 20, wherein a mass flow of working medium or a volume flow of working medium, which is proportional to the rotational speed of the rotor or of the counter-rotor, is injected by the idle pump, whereas the idle pump is driven directly or indirectly in particular by the rotor or the counter-rotor.

26. The method according to claim 20, wherein the working medium storage tank, in non-breaking mode, is vented by means of a ventilation unit down to the ambient pressure.

27. The method according to claim 20, wherein the idle pump comprises an impeller wheel in the form of a disk with a radially internal inlet region for working medium and a radially external outlet region for working medium, whereas the working medium is conveyed from the inlet region to the outlet region and from the latter into the working chamber by driving the impeller wheel and by the effect of the centrifugal force.

28. The method according to claim 20, wherein the working medium is guided from the stock of working medium directly to the inlet region and thereby working medium is conveyed from the stock of working medium into the working chamber.

29. The method according to claim 20, wherein the idle pump is used exclusively for feeding working medium into the working chamber of the hydrodynamic retarder for adjusting the residual amount in non-braking mode.

30. A hydrodynamic retarder comprising:
a rotating bladed rotor and a bladed stator or a bladed counter-rotor rotating against the direction of rotation of the rotor, which in braking mode form together a working chamber which selectively can be filled with a working medium via an inlet and can be drained via an outlet;
wherein, in non-braking mode, working medium is injected into the working chamber from a stock of working medium, which is provided outside the working chamber in a working medium storage tank, using an idle pump.

31. The hydrodynamic retarder according to claim 30, wherein an external cooling circuit is associated with the hydrodynamic retarder for cooling the working medium, comprising the working medium storage tank for absorbing, in a stock of working medium, the working medium which is not situated in the working chamber at that time, whereas the external cooling circuit is connected to the work space via the inlet and the outlet.

32. The hydrodynamic retarder according to claim 30, wherein the idle pump comprises an impeller wheel in particular in the form of a disk, which comprises a radially internal inlet region and a radially external outlet region for working medium, whereas the inlet region is connected to the working chamber for conveying the working medium via the inlet or an additional inlet, in particular in the form of filling slots.

33. The hydrodynamic retarder according to claim 32, wherein the impeller wheel is in a driving connection with the rotor or the counter-rotor or is carried by the same.

34. The hydrodynamic retarder according to claim 32, wherein the inlet region is connected for conveying the working medium with the stock of working medium in the working medium storage tank, in particular parallel to the connection of the working medium storage tank via the external cooling circuit with the inlet.

35. The hydrodynamic retarder according to claim 30, wherein the working medium storage tank comprises a pressurisation system for applying a control pressure by means of a pressure medium to the stock of working medium, to inject more or less working medium into the working chamber, and the working medium storage tank comprises a pressure medium outlet with a ventilation unit.

36. The hydrodynamic retarder according to claim 30, wherein in addition to the outlet, via which the external cooling circuit is connected to the working chamber, a deviation for working medium is provided in non-braking mode, which comprises in particular a pilot tube extending in radial direction to the working chamber and/or projecting into said chamber.

37. The hydrodynamic retarder according to claim 36, wherein the pilot tube is connected in a flow-guiding manner directly with the inlet region or indirectly via at least one connection pipe, which emerges into the inlet region; whereas in particular in which at least one connection pipe a heat exchanger is arranged for cooling the working medium tapped via the pilot tube.

38. The hydrodynamic retarder according to claim 37, wherein the heat exchanger comprises a first cooling system for cooling the working medium tapped via the pilot tube and a second cooling system for cooling the working medium discharged via the outlet.

39. The hydrodynamic retarder according to claim 30, wherein the outer diameter of the idle pump, of at least one impeller wheel of the same is smaller than the outer diameter of the working chamber or is smaller than the diameter, on which the orifice of the inlet is positioned in the working chamber, or is smaller than the inner diameter of the working chamber.
